(19) United States
(12) Patent Application Publication
(10) Pub. No.: US 2026/0044470 A1
(43) Pub. Date: Feb. 12, 2026

(54) METHOD FOR EXTENDING A COMMUNICATION TECHNOLOGY BASED ON POINT-TO-POINT COMMUNICATION

(71) Applicant: Murrelektronik GmbH, Oppenweiler (DE)

(72) Inventors: Franz-Otto WITTE, Kenzingen (DE); Timo SETZER, Mainhardt (DE)

(73) Assignee: Murrelektronik GmbH, Oppenweiler (DE)

(21) Appl. No.: 19/292,966

(22) Filed: Aug. 7, 2025

(30) Foreign Application Priority Data
Aug. 7, 2024 (EP) 24193394.4

(51) Int. Cl. G06F 13/42; G06F 9/448

(52) U.S. Cl. CPC G06F 13/4265; G06F 9/4494

(57) ABSTRACT

The invention relates to a method (100) for extending a communication technology based on point-to-point communication for operating a chain of secondary devices (300) at a common port (210) of a master device (200), where preferably the secondary devices (300) are designed as IO-Link devices, the master device (200) is designed as an IO-Link master and/or the communication technology is designed as IO-Link, in particular for an industrial plant, wherein the method (100) comprises:
Providing (101) data (500) for processing by a currently executing device (301) in the chain, wherein a data block (510) of the data (500) comprises multiple data elements (520) assigned to the various devices (300) in the chain,
Providing (102) at least one data element (530) of the data elements (520) which is provided at a predetermined position in the data block (510) and is therefore assigned to the currently executing device (301) in the chain,
Performing (103) the processing of the data (500), wherein a shift, in particular rotation, of the data elements (520) by a specified number of positions is performed so that, after each forwarding of the data (500) to one of the devices (300) in the chain, the at least one data element (530) assigned to that device (300) is provided to that device (300) at the same predetermined position,
Initiating (104) the forwarding of the data (500) to the device (300) following the device (301) currently executing.

### RELATED APPLICATION(S)

This application claims the benefit of priority of European Patent Application No. 24193394.4 filed on Aug. 7, 2024, the contents of which are all incorporated by reference as if fully set forth herein in their entirety.

### FIELD AND BACKGROUND OF THE INVENTION

The present invention relates to a method for extending a communication technology based on point-to-point communication. Furthermore, the invention relates to a master device, a secondary device, a communication system, a computer program, and a device for this purpose.

### State of the Art

It is known from the prior art that different communication technologies can be used in a communication system for an industrial plant. In addition to a fieldbus system, subordinate communication technologies are also generally used, e.g., for connection to the sensor/actuator level. IO-Link is a standardized communication interface for such a purpose, which enables a point-to-point connection between an IO-Link master and an IO-Link device.

IO-Link is a point-to-point communication technology, which means that each IO-Link device is connected directly to an IO-Link master. The point-to-point connection is particularly advantageous for connecting devices such as sensors and actuators for data exchange and control. These devices usually form an end point. Cascading IO-Link devices is therefore neither intended nor necessary.

However, the usual point-to-point connection configurations are disadvantageous if a cascade of IO-Link devices is functionally useful or necessary. In this case, conventional IO-Link functionality cannot be used directly.

There are a few solutions in which an expansion port is used to connect the IO-Link device to another device. However, this requires a more complex configuration and is limited to one device.

There are also solutions that use a wireless connection. However, these merely transfer the wired point-to-point connection to a wireless technology. Although they offer greater flexibility, they also have technical disadvantages such as higher costs and, depending on environmental conditions, susceptibility to errors.

In addition, solutions are available that are based on the use of an IO-Link hub. However, such solutions do not result in a cascade of IO-Link devices and therefore have a different purpose.

Conventional solutions for extending IO-Link technology are known from, among others, publications CN110266569A, EP3944565A1, DE102016223024A1, and CN117395099A.

It is therefore an object of the present invention to at least partially overcome the disadvantages described above. In particular, it is an object of the present invention to provide an improved means for extending point-to-point communication.

### SUMMARY OF THE INVENTION

The subject matter of the invention is a method with the features of claim 1, a further method with the features of claim 9, a master device with the features of claim 10, a secondary device with the features of claim 11, a communication system with the features of claim 13, a computer program with the features of claim 14, and a device with the features of claim 15. Further features and details of the invention are apparent from the respective subclaims, the description, and the drawings. Features and details described in connection with the method according to the invention also apply, of course, in connection with the further method according to the invention, the master device according to the invention, the secondary device according to the invention, the communication system according to the invention, the computer program according to the invention, and the device according to the invention, and vice versa, so that mutual reference is always possible with regard to the disclosure of the invention.

Subject of the invention is in particular a method, especially for an industrial plant, for extending a communication technology based on point-to-point communication such as IO-Link, preferably for operating a chain of secondary devices, preferably at a common port of a master device, in particular an IO-Link master, preferably an IO-Link master module.

The secondary devices can preferably be designed as IO-Link devices. More generally, the secondary devices can each be designed as an (end) device for a point-to-point connection with a master device. At least one or at least two or at least three of the secondary devices can each comprise an expansion port for a cascade with at least one or at least two or at least three further secondary devices. The chain/cascade can comprise a total of, for example, at least two or at least three or at least four or even more secondary devices. Only one of the secondary devices, in particular a first secondary device, in the chain/cascade can have a direct (point-to-point) connection to the master device. The master device can communicate indirectly with the other secondary devices that do not have a direct connection via the first secondary device in the chain. The processing of the data for communication provided for this purpose is described in more detail below.

In the context of this disclosure, “designed as” may also refer to “configured as or “is””. The secondary devices therefore can be IO-Link devices or each secondary device can be a device for a point-to-point connection with the master device.

The terms ‘particularly’ and ‘preferably’, as used in this disclosure, are to be understood as indicating optional features or effects, in the same way as the term ‘optionally’.

The master device can function as a primary device and, in particular, as an IO-Link master for the communication technology. The communication technology can therefore be implemented as IO-Link. The master device can be designed as a master module with additional connections for connecting to further secondary devices or other IO-Link devices. Furthermore, the master device, and in particular the master module, can also comprise a connection for a fieldbus system.

The method steps of a (first) method according to the invention and/or a further (second) method according to the invention can be carried out at least in part by one or each of the secondary devices in the chain and/or by the master device. Preferably, the first method according to the invention can be carried out by the secondary devices and the further (second) method by the master device.

The method according to the invention may initially comprise providing data for processing by a currently executing device in the chain. The currently executing device in the chain may preferably be any of the secondary devices in the chain which is currently processing and/or receiving and/or transmitting the data. In addition, the currently executing device may be the first secondary device in the chain which is directly, i.e. in particular also electrically and/or mechanically directly, connected to the common port of the master device. The other secondary devices in the chain, on the other hand, may be indirectly connected to the common port of the master device via the first secondary device.

Furthermore, a data block of the data may comprise multiple data elements that are assigned to the various devices in the chain. Thus, not all data elements of the data block that is currently being processed by the first secondary device are also intended for the first secondary device.

The method may also include providing at least one data element of the data elements. The at least one data element provided is provided at a predetermined position in the data block. It can therefore be assigned to the device currently executing in the chain. The predetermined position may, for example, always be the first position in the data block. The predetermined position may be defined identically for all of the secondary devices in the chain.

The method may also comprise: processing the data, wherein, if necessary, the data elements may be shifted, in particular rotated, by a specified number of positions so that, preferably after each forwarding of the data to one of the, particularly secondary, devices in the chain, the at least one data element assigned to that device is provided to this device at the same predetermined position. This ensures that the specified position is defined identically for all secondary devices in the chain.

Furthermore, an initiation of the forwarding of the data to the device following the currently executing device (i.e. particularly to the device subsequent and/or following in the sequence and/or next to the currently executing device) may be provided. Preferably, each of the secondary devices in the chain has only one device following it, since it may preferably be a daisy chain.

The advantage of this method is that the extension and/or retrieval of the assigned at least one data element by a secondary device can be carried out essentially independently of the device, thus minimizing the configuration effort.

It also allows for flexible system configurations, as the devices can perform their functions independently of each other in any position within the chain. By shifting the data elements within the data block, it is ensured that each device in the chain receives exactly the data relevant to it at its specific position. This simplifies configuration and management, as the devices do not need to know their positional relationship in the chain.

The adaptability of the system also makes it possible to add new devices with little effort by dynamically adjusting the data assignment through rotation.

It is also advantageous if, within the scope of the invention, the shifting, in particular rotation, is provided for uniform execution by each of the devices, preferably with a variable number of positions that can be specified for the devices. This can enable the shifting, in particular rotation, of the data elements to be performed by each of the devices in the chain before the respective device initiates forwarding. In this way, it can be ensured that the respective device currently executing the processing of the data can always retrieve the at least one data element assigned to it at the same predetermined position. This greatly simplifies the configuration effort for the devices. Essentially, identical secondary devices can be used to extend the chain with little or no configuration effort.

Furthermore, the number of positions intended for shifting can be specified depending on the number of data elements assigned to the respective device currently executing and processed by the device. Therefore, the number of positions for shifting can be adjusted depending on the number of data elements assigned to the respective device. This enables each device in the chain to process its data elements correctly. Thanks to the shift, the number of data elements assigned to a secondary device in the chain does not need to be known to the other devices in the chain.

Preferably, the method can be provided for repeated execution, successively by the various devices in the chain. Repeated execution of the method by each device in the chain ensures smooth data transfer and processing throughout the system.

Furthermore, within the scope of the invention, it is conceivable that the processing of the data comprises different types of processing operations, preferably a receiving and transmitting operation, preferably a read and write operation, on the at least one assigned data element.

It is also possible that the processing of the data comprises: performing the shifting, in particular rotation, of the data elements in a direction that depends on the type of the current processing operation, preferably in a first direction if it is a receiving or reading operation, and in a direction opposite to the first direction if it is a sending or writing operation. The direction of the shift, i.e., rotation, thus changes depending on the type of the current processing operation. Preferably, the directions are left and right and/or the shift (i.e. shifting/displacement) can be cyclic. This cyclic movement of the data elements enables efficient data processing and transmission in the chain.

It is also optionally conceivable that the data block forms an array with the multiple data elements as array elements. Furthermore, the at least one assigned data element can be provided for each of the devices at the same predetermined position in the array so that the devices can retrieve their at least one assigned data element independently of their position in the chain and/or are agnostic with respect to their position in the chain. This allows each device in the array to access its specific data element independently of its position within the chain system. This approach simplifies implementation, as each device only has to retrieve the element to which it is assigned, regardless of its position in the chain.

Preferably, each of the devices may comprise a configuration that determines the number of data elements that are assigned to the device and processed. Furthermore, the number of assigned data elements may depend on the number of control functions and/or detection functions provided by the device, which are preferably configured and/or set and/or controlled and/or read out by the assigned data elements, preferably via the master device and particularly preferably via a central or decentralized control (control device) of an industrial plant.

Furthermore, each of the devices may comprise a function for specifying the number of positions in order to perform the shifting, in particular rotation, by the number of positions/places corresponding to the number of assigned and processed data elements. In other words, each device in the chain can provide its configuration to indicate how many data elements it processes. This number may depend on the function of the device. Each device can also define the positions for the rotation itself to ensure that the data elements are moved correctly to their position.

In another option, the (secondary) devices in the chain may comprise at least one of the following:
A device for providing at least one control function, preferably for controlling at least one motor and/or at least one light and/or segment lights,
A device for providing at least one detection function, preferably for evaluating a sensor and/or a light barrier and/or a switch,
A device for providing control functions in the form of energy management functions, preferably for monitoring and optimizing energy consumption and/or for controlling energy-saving measures and/or for integration into an energy management system,
A device for providing control functions in the form of temperature control functions, preferably for detecting and controlling the temperature in industrial processes and/or for monitoring temperature limits and/or for controlling heating elements,
A device for providing control functions in the form of positioning and motion detection functions, preferably for positioning machine components and/or for monitoring motion sequences and/or for integration into an automation system,
A device for providing detection functions in the form of communication functions, preferably for connecting and integrating field devices into a higher-level control system and/or for data transmission between machine components,
A device for providing detection functions in the form of diagnostic and maintenance functions, preferably for monitoring and analyzing the device status and/or for early detection of malfunctions and/or for supporting predictive maintenance,
A device for providing detection functions in the form of safety functions, preferably for monitoring and controlling safety zones and/or for triggering safety measures,
A device for providing detection functions in the form of optical recognition functions, preferably for detecting and evaluating image data and/or for supporting quality control processes and/or for identifying objects and their characteristics.

In this way, the chain of devices can fulfill a variety of functions. The flexibility of the chain makes it possible to adapt devices with specific functions to the respective requirements and thus realize a wide range of applications.

Furthermore, it is conceivable that the devices in the chain are connected via a wired connection to each other in a daisy chain configuration for data exchange and preferably energy exchange. This allows the devices in the chain to be connected to each other via a simple cable-connection network. This can reduce installation effort and enable more reliable data transmission, as no wireless connections are required. The daisy chain configuration also enables efficient energy exchange between the devices, improving the overall performance of the system.

It is also conceivable that energy can be supplied to the devices, in particular in addition to the energy supplied by the master device. This means that additional energy can be coupled in, in particular in addition to the energy supplied by the master device. This is preferably possible by connecting at least one connector, in particular a T-connector (also referred to as T-piece), for energy supply to at least one of the devices. In other words, energy can be coupled via the connectors, such as T-connectors, between the cascaded devices. This may involve feeding additional operating voltage into the chain. This is particularly necessary and useful if the energy supply from the master device is not sufficient to supply all the devices connected to it. The connector, preferably T-connector, can accommodate/receive an additional external power supply that is, if necessary, independent of the master device, preferably the IO-Link master. This can be particularly useful for increasing the performance of luminaire circuits in series (daisy chain), i.e., when the devices in the chain are at least partially designed as luminaires.

IO-Link uses in particular a point-to-point connection between a master and a device, with the master supplying power to the device. A third input, provided by a connector, also referred to as connector piece, allows an external power supply to be connected. For the passthrough of an external power supply, for example, an M12 5-pin socket can be used as an input. The connector can be designed to passthrough the external power supply in addition to passing through the power supply of the master device. This means that both the power supply of the master device and the external power supply are passed through from an input of the connector to outputs of the connector. The outputs can comprise a main output and a branch of the connector. The input can, for example, comprise one or two pins for the voltage supply of the master device, which are electrically connected to the main output, for example, and comprise one or two additional pins for the external voltage supply, which are electrically connected to the branch, for example.

In a further embodiment, it may be provided that the data comprise a first data type, in which the data elements are provided as control, configuration, diagnostic, and/or calibration data, and comprise a second data type, in which the data elements are implemented/provided as process data. This enables more efficient processing and organization of the data.

The invention also relates to a further (second) method, in particular for an industrial plant, which is preferably carried out by a master device, in particular one according to the invention.

The method is particularly intended for extending a communication technology based on point-to-point communication for operating at least two secondary devices connected to each other via a wired connection at a common port of a/the master device.

The further method may comprise:
Providing data for processing by all of the (secondary) devices in the chain, wherein preferably a data block of the data is designed/provided to receive and combine multiple data elements that are preferably assigned to the various devices in the chain,
Providing at least one first data element of the data elements at a predetermined position in the data block, preferably in order to assign it to a first (secondary) device in the chain,
Providing at least one further data element sequentially after the at least one first data element in order to assign the at least one further data element to at least one further device in the chain,
Initiating a forwarding of the data, in which the data is output via the common port of the master device for processing by each device in the chain.

The further method according to the invention thus offers the same advantages as those already described above for a first method according to the invention.

Furthermore, the invention may provide that the secondary devices are designed as IO-Link devices and/or the master device is designed as an IO-Link master and/or the communication technology is designed as IO-Link.

The invention also relates to a master device, in particular for an industrial plant, for extending a communication technology based on point-to-point communication for operating a chain of secondary devices at a common port of the master device. A device for data processing may be provided, which is designed to carry out the further/second method according to the invention. The master device according to the invention thus offers the same advantages as those described in detail with reference to a method according to the invention.

The invention also relates to a secondary device, in particular for an industrial plant, for interlinking to at least one or more other secondary devices in a communication system based on point-to-point communication. The secondary device may comprise a data port or device port for receiving data for processing by the secondary device. As already described above, a data block of the data may comprise multiple data elements that are assigned to the devices in the chain.

Furthermore, a data memory of the secondary device according to the invention may be provided for providing at least one data element of the data elements. The at least one data element provided may be provided at a predetermined position in the data block and therefore be assigned to the secondary device.

Furthermore, the secondary device according to the invention may comprise a means for performing the processing of the data. In this case, a shift, in particular a rotation, of the data elements by a specified number of positions may be performed so that, after each forwarding of the data to one of the devices in the chain, the at least one data element assigned to that device is also provided (to it) at the same predetermined position.

In addition, the secondary device according to the invention may comprise an expansion port for the forwarding by outputting the data via the expansion port to a subsequent device.

The secondary device according to the invention offers the same advantages as those described in detail with reference to a method according to the invention. In addition, the secondary device according to the invention may be suitable for executing a method according to the invention. Optionally, it is conceivable that the secondary device has a data processing device for this purpose, which is designed to execute the (first) method according to the invention.

The invention also relates to a communication system, in particular for an industrial plant, comprising a master device according to the invention and at least one or at least two secondary devices according to the invention, wherein the secondary devices are preferably linked to each other in a wired chain and wherein preferably only one of the secondary devices connects the chain to the master device via a common port of the master device. The communication system according to the invention thus offers the same advantages as those described in detail with reference to one of the methods according to the invention. In addition, the communication system may be suitable for executing at least one of the methods according to the invention.

The communication system can be implemented as an IO-Link system. This can comprise the master device in the form of an IO-Link master and the secondary devices in the chain and, if necessary, further devices, each in the form of IO-Link devices. The IO-Link devices can also comprise sensors and actuators. Furthermore, the IO-Link devices can optionally also comprise RFID or NFC readers, valves, motor starters, or IO modules.

The master device preferably establishes the connection between the devices, in particular IO- Link devices, and the automation system. As part of a peripheral system, the master device can be installed, for example, in the control cabinet or as remote I/O, e.g., in protection class IP65/67, directly in the field. The master device is preferably designed to communicate with a control device or other components of the automation system for integration into the automation system via one or more fieldbuses or product-specific backplane buses. However, communication between the master device and the secondary devices is based on point-to-point communication. A master device can comprise several connections for this purpose, preferably IO-Link ports (channels). A secondary device, in particular an IO-Link device, can be connected to each connection (point-to-point communication). Thus, the communication technology provided, specifically IO-Link, is point-to-point communication and not a fieldbus. Point-to-point communication therefore refers in particular to the fact that the communication technology is designed so that secondary devices are each connected to a separate port of the master device for communication. According to the invention, an extension can be provided here in the sense that not only a single secondary device can be connected to a port of the master device, but several secondary devices can be connected to a common port of the master device.

The invention also relates to a data processing device comprising means for executing the steps of at least one of the methods according to the invention. The data processing device according to the invention thus offers the same advantages as described in detail with reference to a method according to the invention.

The invention also relates to a computer program, in particular a computer program product, comprising commands which, when the computer program is executed by a computer, cause the computer to execute at least one of the methods according to the invention. The computer program according to the invention thus offers the same advantages as those described in detail with reference to a method according to the invention. The computer program may also be at least partially non-volatile and/or available as software for download and/or as a cloud service and/or as an executable program and/or as a configuration file and/or as a program library and/or as source code and/or in compiled and/or encrypted and/or compressed form and/or in a combination thereof.

The computer may be a data processing device, preferably the data processing device according to the invention.

The data processing device according to the invention and preferably the computer may be designed to execute the computer program according to the invention. For this purpose, the data processing device according to the invention may comprise at least one processor. A non-volatile data memory may also be provided in which the computer program is stored and from which the computer program can be read out by the processor for execution.

It is also conceivable that the data processing device according to the invention comprises at least one integrated circuit such as a microprocessor or an application-specific integrated circuit (ASIC) or an application-specific standard product (ASSP) or a digital signal processor (DSP) or a field programmable gate array (FPGA) or the like. The data processing device according to the invention or the computer can thus also be designed as an electronic circuit.

The data processing device according to the invention may further comprise at least one interface for data exchange, e.g., an Ethernet interface or an interface for LAN (local area network) or WLAN (wireless local area network) or system-on-a-chip (SoC) or another radio interface such as for Bluetooth or near field communication (NFC). Furthermore, the data processing device according to the invention can be designed as one or more control devices, i.e. also as a system of control devices. The data processing device according to the invention can also be provided completely or partially in a cloud and/or as a server in order to make the data processing available via the interface for a local application. Accordingly, the data processing device according to the invention may also be designed as a distributed system. It is also possible for the data processing device according to the invention to be designed as a mobile device, such as a smartphone.

The invention may also relate to a computer-readable storage medium comprising the computer program according to the invention. The storage medium is designed, for example, as a data storage device such as a hard disk and/or a non-volatile memory and/or a memory card. The storage medium may be integrated, for example, in the computer and/or in the data processing device according to the invention.

In addition, the respective method according to the invention can also be implemented as a computer-implemented method. Alternatively or additionally, each individual or all of the disclosed method steps can optionally be computer-implemented and/or performed automatically.

Furthermore, the respective method according to the invention may be provided for providing and/or extending communication in an industrial plant, preferably for providing and/or extending communication with the secondary devices of the industrial plant. The industrial plant is, for example, an automation plant and/or an electrical and/or pneumatic and/or fluid engineering and/or hydraulic plant.

### BRIEF DESCRIPTION OF THE SEVERAL VIEWS OF THE DRAWING(S)

Further advantages, features, and details of the invention are apparent from the following description, in which embodiments of the invention are described in detail with reference to the drawings. The features mentioned in the claims and in the description may be essential to the invention individually or in any combination. Shown are:

FIG. 1 a schematic representation of a respective method according to embodiments of the invention.

FIG. 2 a schematic representation of a communication system according to embodiments of the invention.

FIG. 3 a further illustration of details of a method according to embodiments of the invention.

FIG. 4 a further illustration of details of a method according to embodiments of the invention.

### DESCRIPTION OF SPECIFIC EMBODIMENTS OF THE INVENTION

In the following figures, the same reference symbols are used for the same technical features, even if they are from different embodiments.

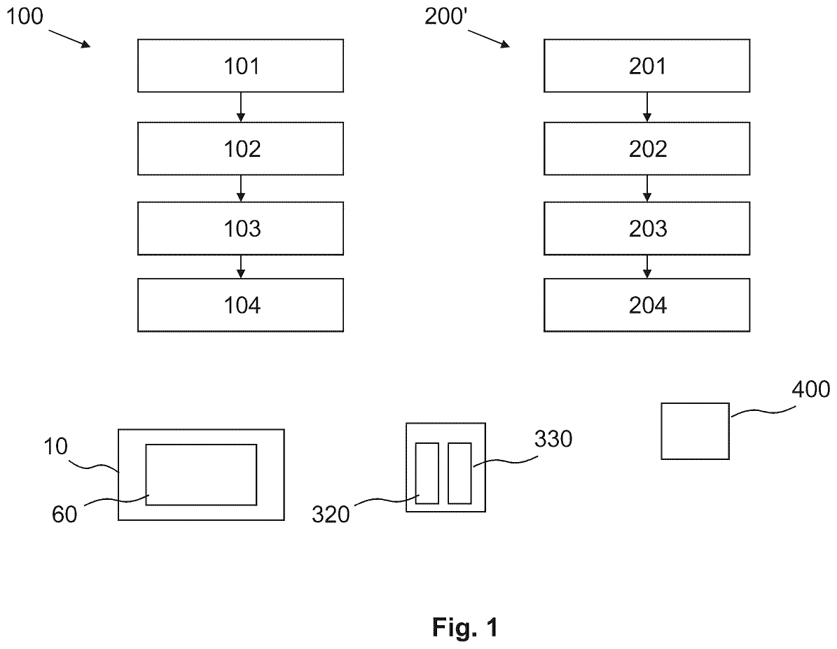

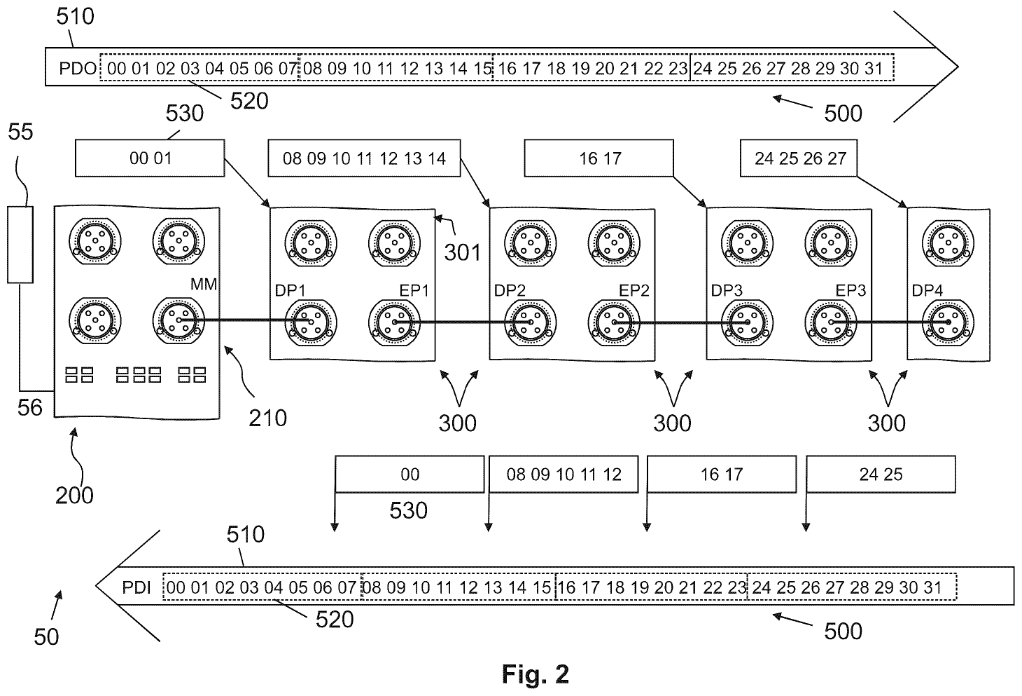

FIGS. 1 and 2 illustrate, according to embodiments of the invention, a first and second method 100, 200′ for extending a communication technology based on point-to-point communication for operating a chain of secondary devices 300 at a common port 210 of a master device 200. Furthermore, a master device 200, a secondary device 300, a communication system 50, a computer program 60, and a device 10 for data processing for this purpose are shown, each according to embodiments of the invention. A connector 400 is also shown as an example.

According to a first method step 101 shown in FIG. 1, data 500 is provided for processing by a currently executing device 301 in the chain, wherein a data block 510 of the data 500 comprises multiple data elements 520 that are assigned to the various devices 300 in the chain. According to a second method step 102, at least one data element 530 of the data elements 520, which is provided at a predetermined position in the data block 510 and is therefore assigned to the currently executing device 301 in the chain, is made available. Then, according to a third method step 103, the data 500 can be processed. In this case, the data elements 520 can be shifted, in particular rotated, by a specified number of positions so that, after each forwarding of the data 500 to one of the devices 300 in the chain, the at least one data element 530 assigned to this device 300 is provided to this device 300 at the same predetermined position. Then, according to a fourth method step 104, an initiation 104 of the forwarding of the data 500 to the device 300 following the currently executing device 301 may be provided.

The first method 100 describes in particular the receiving and forwarding of the data 500. The initial transmission of the data 500 may be provided by a further method 200′.

The second method 200′ can preferably be executed by the master device 200 and, according to embodiments of the invention, comprises providing 201 data 500 for processing by all of the devices 300 in the chain, providing 202 at least one first data element 530 of the data elements 520 at a predetermined position in the data block 510, providing 203 at least one further data element 520 sequentially after the at least one first data element 530, and initiating 204 a forwarding of the data 500, in which the data 500 is output via the common port 210 of the master device 200 for processing by each device 300 in the chain.

A master device 200 can be designed to extend a communication technology based on point-to-point communication for operating a chain of secondary devices 300 at a common port 210 of the master device 200. The secondary device 300 can comprise a data port/device port DP for receiving data 500 for processing by the secondary device 301. Furthermore, a data memory 330 may be provided for supplying 102 at least one data element 530 of the data elements 520. The secondary device 300 may also comprise a means 320 such as a computer program or part of a computer program or a processor for performing 103 the processing of the data 500. In addition, an expansion port EP may be provided for forwarding by outputting 104 the data 500 via the expansion port EP to a subsequent device 300.

The communication system 50 is shown in more detail in FIG. 2. In addition to the master device 200 and at least two secondary devices 300, it may also comprise a central control device 55 which is connected to the master device 200 via a fieldbus 56. The communication system 50 may comprise a communication technology based on point-to-point communication, such as IO-Link, as the communication technology for connecting the secondary devices 300.

IO-Link is a standardized communication interface for the sensor/actuator level that enables a point-to-point connection between an IO-Link master 200 and an IO-Link device 300. The secondary devices 300 and, if applicable, the IO-Link devices are also referred to briefly as devices in the context of the invention.

An exemplary embodiment of the invention is described in more detail below. Each of the features described is exemplary and is therefore not necessarily related to the other features described, which can therefore also be claimed individually.

The IO-Link master 200 is the central control device that manages communication with the connected IO-Link devices. The IO-Link master can be connected to a PLC 55 via a fieldbus 56.

The IO-Link device 300 is, for example, a sensor, an actuator, or another device that communicates via IO-Link. Examples include pressure sensors, temperature sensors, or valves.

The connection between the IO-Link master and the IO-Link device can be established using a standard 3-wire cable, for example. The cable transmits both the power supply and the communication signals, if necessary.

The IO-Link master sends and receives digital data to and from the connected IO-Link devices. Communication is cyclical and acyclical. Cyclical data is usually process data such as measured values, while acyclical data includes configuration or diagnostic information.

Each IO-Link device has a so-called IODD (IO Device Description) that describes the specific characteristics and communication parameters of the device. This IODD file is loaded into the IO-Link master to configure and monitor communication.

Cascading IO-Link devices is not normally intended. IO-Link is a point-to-point communication technology, which means that each IO-Link device is connected directly to an IO-Link master.

However, according to embodiments of the invention, a device-independent extension is provided, in which a cascade of several IO-Link devices is possible. Embodiments of the invention therefore have the advantage that no complex and specific configuration of the devices to be extended is necessary and the extension is not limited to a single device.

A first IO-Link device 301 shown in FIG. 2 can be connected to the master module (MM) via a DP (data or device port), for example. The first IO-Link device can also comprise an expansion port (EP). A second IO-Link device can be connected to the first IO-Link device. To do this, the DP port of the second IO-Link device is connected to the EP port of the first IO-Link device. In the same way, further IO-Link devices can be linked to each other in a cascading daisy chain configuration.

Process data is used for communication between the master 200 and the IO-Link devices 300. This data can be divided into PDO (process data output) and PDI (process data input) (see FIG. 2). PDOs contain the outgoing control commands or setpoints that are sent by the IO-Link master to the connected devices. PDIs, on the other hand, comprise the incoming sensor data or feedback that is transmitted from the IO-Link devices to the IO-Link master. In addition, IO-Link devices can also use acyclic data transfers via ISDU (Indexed Service Data Unit) to exchange configuration, diagnostic, or calibration data. The principle described below can therefore be used for both PDO and PDI process data as well as for other data structures such as ISDU.

With the device-independent extension according to the embodiment variants of the invention, the number of expandable IO-Link devices is not limited to 1, but by the process data length of 32 bytes IN/OUT.

An example is the use of segment lights as IO-Link devices 300. For example, 8 bytes can be specified for a 5-segment light. This means that in this case, you can cascade 4×5 segment lights or 2×10-segment-lights or a combination of 2×5 segment lights with one 10-segment-light, etc.

The process is not limited to segment lights. If IO modules (hubs) or other IO-Link devices are used, the 8 bytes can still be used to combine the various devices with each other.

The devices then comprise, for example, a stand-alone and 3 daisy chain IDs that determine the data length (in IO-Link, a device ID can only have one data length).

FIGS. 2 to 4 illustrate how this works. Each device receives or sends a total of 8 bytes, but only uses the data it needs or returns it.

Examples of the invention relate to a communication system for cascading and, in particular, daisy chaining multiple devices 300 (also known as chain devices or CDs). A fixed size can be specified for the process data transmission (e.g., PDOut: 32 bytes and PDIn: 2 bytes).

Furthermore, TYP_2_V can be specified as the frame type/M sequence type, which allows flexible arrangement of the devices.

Each secondary device 300 can be used at any point in the chain and perform its function independently of its position. The master, in particular the main master or MM for short, communicates exclusively with the first device 301, in particular the chain device or CD1, which, for example, emulates a single device with a larger number of segments.

The system can also comprise a hot-plugging function. The hot-plugging function is ensured, for example, by checking the “port status” at the expansion port of each CD. Each CD preferably implements the IO-Link functionality at the data or device port (DP) for communication with the MM. The use of an additional IO-Link protocol at the expansion port (EP) is possible, but can be omitted to avoid complexity.

The data structure and organization within the CDs are preferably identical regardless of their position in the chain. The master device 200 and/or the first device 301 in the chain acts, for example, as a central control unit and forwards all information to the subsequent devices.

By regularly checking the port status at the EP, chain devices can detect the connection of new devices and adapt accordingly. IO-Link devices of the same type are distinguished by means of vendor IDs (VID) and device IDs (DID), for example.

One particular advantage of the invention's design variants is that a CD does not “know” its position in the chain. This means that the data set applied to each CD can be identical, the structure of the process data can be identical for each CD, the location of the process data and variables for local characteristics can always be found in the same place, and the content of the process data and variables for local characteristics can be customized for each CD.

In order to meet the above requirements, a shift-in particular in the form of a rotation-of the process data may be provided. This means that the position of the process data for each forwarding to a received CD within the chain can be adjusted so that the received CD always finds the data relevant to it at the same location. One way of implementing this is to rotate the positions with each forwarding.

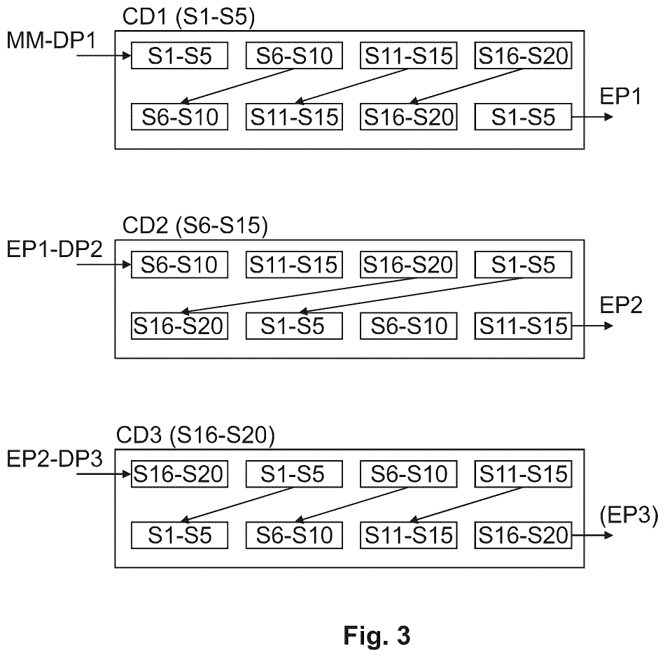

FIG. 3 shows an example of how array elements are used to control LED segments (S1 to S20). The elements are grouped in groups of five or ten segments. They are sent from the main master “MM” to chain device #1. CD1 is, for example, a 5-segment module and therefore uses the control information for the first five segments S1 to S5. The control information forwarded from CD1 to CD2 is rotated to the left by the number of combined control segment array elements. After rotation, CD2 receives the control information S6 at the first position in its control data. CD2 is a 10-segment device and therefore uses the control data for segments S6 to S15, which are now located at the first ten positions in the control array.

The ten segments used by CD2 are rotated to the left before all array elements are forwarded to CD3 again, now with S16 in the first position. CD3 uses the first five array elements and rotates them to the left as if they were to be forwarded to a subsequent CD4 (which does not exist in this example). The rotation of data elements can be used for both ISDU parameters and process data.

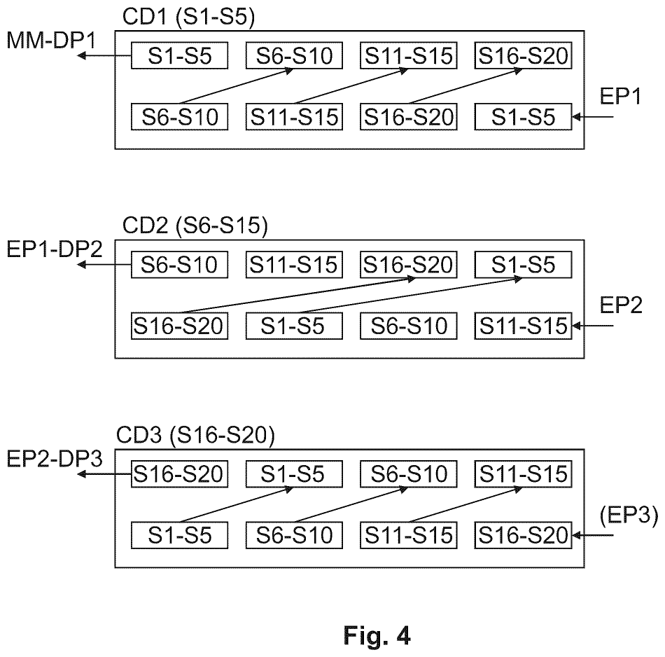

The rotation of the array elements allows additional chain devices to be connected. If another CD4 is connected to EP3, it receives the same segment information that was sent to CD1. In this case, the configuration characteristics of additional segments are defined modulo 20. For incoming status information, the rotation should be in the opposite direction (from left to right), as shown in FIG. 4.

The above description of the embodiments describes the present invention exclusively in the context of examples. Of course, individual features of the embodiments can be freely combined with each other, if technically meaningful, without leaving the scope of the present invention.

### List of Reference Signs

10 Data processing device
50 Communication system
55 Control device, PLC
56 Fieldbus
60 Computer program
100 Method
200 Master device
200′ Further Method
210 Port
300 Secondary device, devices
301 First device
320 Means
330 Data memory
400 Connector, T-connector
500 Data
510 Data block
520 Data elements
530 Assigned data element
DP Data port/Device port
EP Expansion port

1. A method for extending a communication technology based on point-to-point communication for operating a chain of secondary devices at a common port of a master device, wherein the method comprises:
Providing data for processing by a currently executing device in the chain, wherein a data block of the data comprises multiple data elements assigned to the various devices in the chain,
Providing at least one data element of the data elements which is provided at a predetermined position in the data block and is therefore assigned to the currently executing device in the chain,
Performing the processing of the data, wherein a shift of the data elements by a specified number of positions is performed so that, after each forwarding of the data to one of the devices in the chain, the at least one data element assigned to that device is provided to that device at the same predetermined position,
Initiating the forwarding of the data to the device following the device currently executing.

2. The method according to claim 1,
wherein the shifting is provided for uniform execution by each of the devices, in order to enable the shifting of the data elements to be executed by each of the devices in the chain before the device initiates the forwarding, in order to ensure that the respective device which is currently executing the processing of the data, can always retrieve the at least one data element assigned to it at the same predetermined position, the number of positions provided for the shift being specified dependent on the number of data elements assigned to the respective currently executing device and processed by the device.

3. The method according to claim 1,
wherein the execution of the processing of the data comprises different types of processing operations on the at least one assigned data element, and further comprises:
Performing the shifting of the data elements in a direction that depends on the type of the current processing operation.

4. The method according to claim 1,
wherein the data block forms an array with the multiple data elements as array elements, wherein the provision of the at least one assigned data element for each of the devices is performed at the same predetermined position in the array so that the devices can retrieve their at least one assigned data element independently of their position in the chain and/or are agnostic with respect to their position in the chain.

5. The method according to claim 1,
wherein each of the devices has a configuration that determines the number of data elements that are assigned to the device and are processed,
wherein the number of assigned data elements depends on the number of control functions and/or detection functions provided by the device, which are configured and/or set and/or controlled and/or read out by the assigned data elements,
wherein each of the devices has a function for specifying the number of positions in order to perform the shifting by the number of positions corresponding to the number of assigned and processed data elements.

6. The method according to claim 1,
wherein the devices in the chain comprise at least one of the following:
A device for providing at least one control function,
A device for providing at least one detection function,
A device for providing control functions in the form of energy management functions,
A device for providing control functions in the form of temperature control functions,
A device for providing control functions in the form of positioning and motion detection functions,
A device for providing detection functions in the form of communication functions,
A device for providing detection functions in the form of diagnostic and maintenance functions,
A device for providing detection functions in the form of safety functions,
A device for providing detection functions in the form of optical recognition functions.

7. The method according to claim 1,
wherein the devices in the chain are connected via a wired connection to each other in a daisy chain configuration for data exchange.

8. The method according to claim 1,
wherein the data comprise a first data type, in which the data elements are provided as control, configuration, diagnostic, and/or calibration data, and comprise a second data type, in which the data elements are implemented as process data.

9. The method according to claim 1,
wherein the secondary devices are designed as IO-Link devices, the master device is designed as an IO-Link master and/or the communication technology is designed as IO-Link, for an industrial plant.

10. The method according to claim 1,
wherein the shift of the data elements is configured as a rotation of the data elements.

11. The method according to claim 7,
wherein the devices in the chain are connected via the wired connection to each other in the daisy chain configuration for the data exchange and energy exchange, wherein an energy supply to the devices is carried out, by means of at least one connector, connected to at least one of the devices for energy supply, which is provided in addition to the energy supply by the master device.

12. A method for extending a communication technology based on point-to-point communication for operating at least two secondary devices connected to each other via a wired connection at a common port of a master device, comprising the following steps, which are performed by the master device:
Providing data for processing by all of the devices in the chain, wherein a data block of the data is provided to receive and combine multiple data elements that are assigned to the various devices in the chain,
Providing at least one first data element of the data elements at a predetermined position in the data block in order to assign it to a first device in the chain,
Providing at least one further data element sequentially after the at least one first data element in order to assign the at least one further data element to at least one further device in the chain,
Initiating a forwarding of the data, in which the data is output via the common port of the master device for processing by each device in the chain.

13. A master device for extending a communication technology based on point-to-point communication for operating a chain of secondary devices at a common port of the master device, comprising a data processing device which is designed to carry out the method according to claim 12.

14. A secondary device for interlinking to at least one other secondary device in a communication system based on point-to-point communication, comprising:
A data port for receiving data for processing by the secondary device, wherein a data block of the data comprises multiple data elements assigned to the devices in the chain,
A data memory for providing at least one data element of the data elements which is provided at a predetermined position in the data block and is therefore assigned to the secondary device,
A means for performing the processing of the data, wherein a shift of the data elements by a specified number of positions is performed so that, after each forwarding of the data to one of the devices in the chain, the at least one data element assigned to that device is also provided at the same predetermined position,
An expansion port for forwarding by outputting the data via the expansion port to a subsequent device.

15. A communication system comprising a master device according to claim 13 and at least two secondary devices, wherein the secondary devices are linked to each other in a wired chain, and wherein only one of the secondary devices connects the chain to the master device via a common port of the master device.

16. A data processing device, which is designed to carry out the method according to claim 1.

17. A non-transitory computer-readable medium storing computing instructions for data processing, the computing instructions, when executed by one or more processors, cause the one or more processors to:
Provide data for processing by a currently executing device in a chain of secondary devices, wherein a data block of the data comprises multiple data elements assigned to the various devices in the chain,
Provide at least one data element of the data elements which is provided at a predetermined position in the data block and is therefore assigned to the currently executing device in the chain,
Perform the processing of the data, wherein a shift of the data elements by a specified number of positions is performed so that, after each forwarding of the data to one of the devices in the chain, the at least one data element assigned to that device is provided to that device at the same predetermined position,
Initiate the forwarding of the data to the device following the device currently executing.
